(19) United States
(12) Patent Application Publication
(10) Pub. No.: US 2026/0187649 A1
(43) Pub. Date: Jul. 2, 2026

(54) METHOD AND SYSTEM FOR RESOLVING AN ANOMALY

(71) Applicant: JPMorgan Chase Bank, N.A., New York, NY (US)

(72) Inventors: Sugandh SHAH, Hyderabad (IN); Vinod Kumar SHETTY, Hyderabad (IN); Surya Kiran NEKKANTI, Sangareddy (IN)

(73) Assignee: JPMorgan Chase Bank, N.A., New York, NY (US)

(21) Appl. No.: 19/436,134

(22) Filed: Dec. 30, 2025

(30) Foreign Application Priority Data
Jan. 1, 2025 (IN) 202511000035

(51) Int. Cl. G06Q 30/015

(52) U.S. Cl. CPC G06Q 30/015

(57) ABSTRACT

A method and system to resolve an anomaly are disclosed. The method includes receiving a trigger for at least one anomaly detected by an entity. Next, the method includes collecting a set of data associated with the anomaly based on the trigger. Next, the method includes analyzing the set of data to generate a context associated with the anomaly. Next, the method includes transmitting at least one query to the entity based on the generated context. Next, the method includes receiving a response for the at least one query from the entity. Thereafter, the method includes generating a ticket for resolution of the anomaly, wherein the ticket is generated based on the response received from the entity on the at least one query.

### CROSS-REFERENCE TO RELATED APPLICATIONS

This application claims priority benefit from Indian Application No. 202511000035, filed on January 01, 2025, in the India Patent Office, which is hereby incorporated by reference in its entirety.

### FIELD OF THE DISCLOSURE

This technology generally relates to anomaly detection, and more particularly relates to a method and system to resolve an anomaly.

### BACKGROUND INFORMATION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as an admission of the prior art.

As per current trends, for interacting with the users and resolving their queries and issues, service providers of various fields, such as, e-commerce platform, finance platform, and product manufacturers utilize automated systems such as conversational AI based chatbots. With the help of the automated system, the users may interact with applications of the service providers to get service or support. The automated systems have made the customer service more accessible to the user, but they face challenges to build an accurate context around the issue for better service support. In particular, such automated systems primarily rely on user-provided descriptions, keywords, and expressions to infer the context of an issue, thereby making accurate context construction highly dependent on the quality and completeness of the user input. Since the automated system may not have relevant context of the issue, the automated system may ask a series of mundane questions to the user and still fails to build an accurate context around the issue. These follow-up questions are often generic and repetitive in nature, requiring the user to repeatedly restate information or provide additional details, which adversely impacts user experience. Further, the accuracy of questions is also not relevant. Therefore, the user usually ends up using other channels (such as in person visit or call customer support) to get the service or support. This results in reducing the number of users that would visit the automated system. Furthermore, the automated system may lack understanding of language used by the user, particularly in scenarios where the user is not fluent in the supported language or is unable to precisely articulate technical issues, resulting in omission of critical information and incomplete contextual understanding. Further, even when an issue is logged through the automated system, the lack of comprehensive and accurate contextual information often leads to repeated follow-ups by support personnel, delayed root-cause analysis, and prolonged issue resolution cycles. Further, to address or report any issue with these automated systems is not convenient.

Hence, in view of these and other existing limitations, there arises an imperative need to provide an efficient solution to overcome the above-mentioned limitations and to provide a method and system to efficiently resolve an anomaly.

### SUMMARY

The present disclosure, through one or more of its various aspects, embodiments, and/or specific features or sub-components, provides, inter alias, various systems, servers, devices, methods, media, programs, and platforms to resolve an anomaly.

According to an aspect of the present disclosure, a method for resolving an anomaly is disclosed. The method is implemented by at least one processor. The method includes receiving, by the at least one processor, a trigger for at least one anomaly detected by an entity. The method further includes collecting, by the at least one processor, a set of data associated with the anomaly based on the trigger. The method further includes analyzing, by the at least one processor, the set of data to generate a context associated with the anomaly. The method further includes transmitting, by the at least one processor, at least one query to the entity based on the generated context. The method further includes receiving, by the at least one processor, a response for the at least one query from the entity. Thereafter, the method includes generating, by the at least one processor, a ticket for resolution of the anomaly, wherein the ticket is generated based on the response received from the entity on the at least one query.

In accordance with an exemplary embodiment, the trigger may be received from the entity via activating or touching at least one from among a specific region, icon, button, and widget on an application. The trigger may be activated via at least an audio input.

In accordance with an exemplary embodiment, the set of data may include at least one from among screenshots, timestamps, and log details associated with the anomaly.

In accordance with an exemplary embodiment, the set of data may be analyzed using a machine learning based trained model.

In accordance with an exemplary embodiment, the machine learning based model may be trained using at least one from among convolutional neural network (CNN) algorithms, natural language processing algorithms, reinforcement learning algorithms, anomaly detection algorithms and image/vision capturing and processing algorithms.

In accordance with an exemplary embodiment, the set of data associated with the anomaly may be collected after pre-configured time duration of the received trigger.

In accordance with an exemplary embodiment, the response may include at least one from among a positive feedback, a confirmation, a negative feedback, ratings, and a disapproval.

According to another aspect of the present disclosure, a computing device configured to implement an execution of a method to resolve an anomaly is disclosed. The computing device may include at least one processor, a memory storing instructions and a communication interface coupled to each of the at least one processor and memory. The processor may be programmed to cooperate with the instructions to perform operations including receiving a trigger for at least one anomaly detected by an entity; collecting a set of data associated with the anomaly based on the trigger; analyzing the set of data to generate a context associated with the anomaly; transmitting at least one query to the entity based on the generated context; receiving a response for the at least one query from the entity; and generating a ticket for resolution of the anomaly, wherein the ticket is generated based on the response received from the entity on the at least one query.

In some embodiments according to the computing device, the trigger may be received from the entity via activating or touching at least one from among a specific region, icon, button, and widget on an application. The trigger may be activated via at least an audio input.

In some embodiments according to the computing device, the set of data may include at least one from among screenshots, timestamps, and log details associated with the anomaly.

In some embodiments according to the computing device, the set of data is analyzed using a machine learning based trained model.

In some embodiments according to the computing device, the machine learning based model may be trained using at least one from among convolutional neural network (CNN) algorithms, natural language processing algorithms, reinforcement learning algorithms, anomaly detection algorithms and image/vision capturing and processing algorithms.

In some embodiments according to the computing device, the set of data associated with the anomaly is collected after pre-configured time duration of the received trigger.

In some embodiments according to the computing device, the response may include at least one from among a positive feedback, a confirmation, a negative feedback, ratings, and a disapproval.

According to yet another aspect of the present disclosure, a non-transitory computer-readable storage medium storing instructions to resolve an anomaly is disclosed. The instructions include executable code which, when executed by a processor, may cause the processor to perform operations including receiving a trigger for at least one anomaly detected by an entity; collecting a set of data associated with the anomaly based on the trigger; analyze the set of data to generate a context associated with the anomaly; transmitting at least one query to the entity based on the generated context; receiving a response for the at least one query from the entity; and generating a ticket for resolution of the anomaly, wherein the ticket is generated based on the response received from the entity on the at least one query.

In some embodiments according to the non-transitory computer-readable storage medium, the trigger may be received from the entity via activating or touching at least one from among a specific region, icon, button, and widget on an application. The trigger may be activated via at least an audio input.

In some embodiments according to the non-transitory computer-readable storage medium, the set of data may include at least one from among screenshots, timestamps, and log details associated with the anomaly.

In some embodiments according to the non-transitory computer-readable storage medium, the set of data may be analyzed using a machine learning based trained model.

In some embodiments according to non-transitory computer-readable storage medium, the machine learning based model may be trained using at least one from among convolutional neural network (CNN) algorithms, natural language processing algorithms, reinforcement learning algorithms, anomaly detection algorithms and image/vision capturing and processing algorithms.

In some embodiments according to the non-transitory computer-readable storage medium, the set of data associated with the anomaly may be collected after pre-configured time duration of the received trigger.

In some embodiments according to the non-transitory computer-readable storage medium, the response may include at least one from among a positive feedback, a confirmation, a negative feedback, ratings, and a disapproval.

### BRIEF DESCRIPTION OF THE DRAWINGS

The present disclosure is further described in the detailed description which follows, about the noted plurality of drawings, by way of non-limiting examples of exemplary embodiments of the present disclosure, in which characters represent like elements throughout the several views of the drawings.

FIG. 1 illustrates an exemplary computer system to resolve an anomaly, in accordance with an exemplary embodiment of the present disclosure.

FIG. 2 illustrates an exemplary diagram of a network environment to resolve an anomaly, in accordance with an exemplary embodiment of the present disclosure.

FIG. 3 illustrates an exemplary system to resolve an anomaly, in accordance with an exemplary embodiment of the present disclosure.

FIG. 4 illustrates an exemplary method flow diagram to resolve an anomaly, in accordance with an exemplary embodiment of the present disclosure.

FIG. 5 illustrates an architecture of a system to resolve an anomaly, in accordance with an exemplary embodiment of the present disclosure.

FIG. 6 illustrates a process flow of a system for resolving an anomaly, in accordance with an exemplary embodiment of the present disclosure.

FIG. 7 illustrates a process flow of a system for resolving an anomaly in a web-based application environment, in accordance with an exemplary embodiment of the present disclosure.

### DETAILED DESCRIPTION

Exemplary embodiments now will be described with reference to the accompanying drawings. The disclosure may, however, be embodied in many different forms and should not be construed as limited to the embodiments set forth herein; rather, these embodiments are provided so that this disclosure will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items. Also, as used herein, the phrase “at least one” means and includes “one or more” and such phrases or terms can be used interchangeably.

Unless otherwise defined, all terms (including technical and scientific terms) used herein have the same meaning as commonly understood by one of the ordinary skills in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections and the actual physical connections may be different.

In addition, all logical units and/or controllers described and depicted in the figures may include the software and/or hardware components required for the unit to function. Further, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the disclosure. It will be apparent, however, that the disclosure may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer-readable medium having instructions stored thereon for one or more aspects of the present technology as described and illustrated by way of the examples herein. The instructions in some examples may include executable code that, when executed by one or more processors, causes the processors to carry out steps necessary to implement the methods of the examples of this technology that are described and illustrated herein.

As mentioned earlier, existing automated customer-support systems, such as conversational AI chatbots used by e-commerce, finance, and product manufacturers, suffer from concrete technological deficiencies in how they construct and maintain issue context. Specifically, these systems rely almost exclusively on incomplete and unstructured user-provided inputs (e.g., keywords or free-form descriptions), which results in inaccurate context modeling, repetitive system prompts, inefficient dialog flows, and failure to capture technically relevant information. These deficiencies may be exacerbated when users lack fluency in the supported language or are unable to precisely articulate technical problems, leading to missing data, misclassification of issues, and increased system-to-human escalation.

From a system’s perspective, these limitations may cause measurable degradation in automated support performance, including increased interaction cycles, redundant data collection, delayed root-cause analysis, inefficient downstream ticket handling, and prolonged resolution times. As a result, users abandon automated platforms in favor of manual channels, reducing system utilization and undermining the intended scalability of automated support infrastructure.

Accordingly, there exists a technical need for an improved computer-implemented method and system that enhances contextual understanding, reduces redundant user-system interactions, and enables more accurate anomaly identification and resolution within automated support environments. The disclosed solution addresses these technical shortcomings by improving how automated systems acquire, construct, and utilize contextual information, thereby delivering a concrete technological improvement to the operation and effectiveness of automated customer-support systems rather than merely automating a human support workflow.

For example, currently, there is notable absence of systems or products that offer precise and comprehensive assistance for users or customers in automated systems such as conversational AI based chatbots. While service providers of different industries or business sectors use various automated systems in their applications for providing services to their users or customers, they often fall short when applied to address or report any issues and challenges faced by the users during usage of the applications. Existing solutions typically provide a plurality of questions or queries, which do not precisely address the context of the user’s issue, and the plurality of questions may provide unpleasant user experience and wastage of user’s time. As a result, there remains a significant gap in providing precise and contextually accurate queries for resolving issues or anomalies faced by the users or customers in the applications of service providers.

The present disclosure solves the aforementioned problems by providing a method and system to resolve an anomaly. In the present disclosure, at first, the system receives a trigger for at least one anomaly detected by an entity. Further, the system collects a set of data associated with the anomaly based on the trigger. Further, the system analyzes the set of data to generate a context associated with the anomaly. Further, the system transmits at least one query to the entity based on the generated context. Further, the system receives a response for the at least one query from the entity. Thereafter, the system generates a ticket for resolution of the anomaly, wherein the ticket is generated based on the response received from the entity on the at least one query.

The present disclosure reduces the time required by conversational AI–based chatbot systems to accurately capture issue context and automatically generate a support ticket on behalf of a user. By improving how contextual information is collected, structured, and associated with a reported issue during the interaction, the disclosed method/system minimizes redundant user prompts and incomplete data capture at the point of ticket creation.

As a result, downstream technical support systems receive support tickets with more complete and accurate contextual data, enabling faster triage, more efficient root-cause analysis, and reduced resolution times for application-level issues. This improvement directly enhances the operational efficiency of automated support infrastructure and reduces reliance on manual intervention by human support agents.

By addressing a technical limitation in existing chatbot architectures, e.g., deficient context construction during automated interactions, the disclosed method/system improves the functioning of computer-based customer support systems themselves. The solution as disclosed herein may be implemented as a scalable, computer-implemented mechanism that may be integrated across different applications and domains, thereby enabling consistent improvements in automated issue reporting and resolution without modifying underlying business workflows.

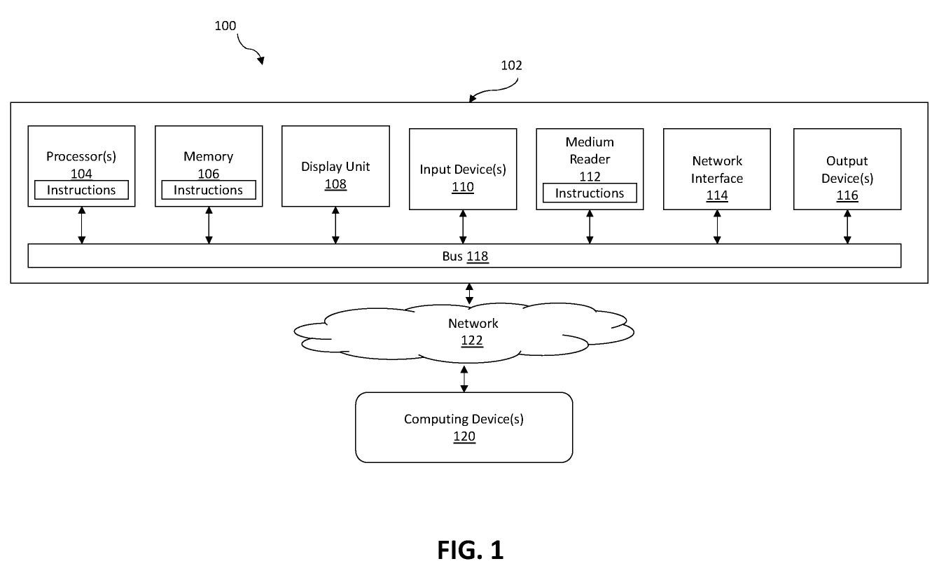

FIG. 1 is an exemplary system for use in accordance with the embodiments described herein. The system 100 is generally shown and may include a computer system 102 which is generally indicated. The term “computer system” may also be referred to herein as “computing device” and such phrases/terms can be used interchangeably in the specifications.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks, or cloud-based environments. Even further, the instructions may be operative in such a cloud-based computing environment.

In a networked deployment, the computer system 102 may operate in the capacity of a server or as a client-user computer in a server-client user network environment, a client-user computer in a cloud-based computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application-specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in or coupled to, a single device or multiple devices.

The computer system 102 may also include a computer memory 106. The computer memory 106 may include a static memory, a dynamic memory, or both in communication. Memories described herein are tangible storage mediums that can store data and executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are of an article about manufacture and/or machine components. Memories described herein are computer-readable mediums from which data and executable instructions can be read by a computer. Memories, as described herein, may be random access memory (RAM), read-only memory (ROM), flash memory, electrically programmable read-only memory (EPROM), electrically erasable programmable read-only memory (EEPROM), registers, a hard disk, a cache, a removable disk, tape, compact disk read-only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. As regards the present disclosure, the computer memory 106 may comprise any combination of memories or a single storage.

The computer system 102 may further include a display unit 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor 104, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as but not limited to, a network interface 114 and an output device 116. The output device 116 may include but is not limited to, a speaker, an audio out, a video out, a remote-controlled output, a printer, or any combination thereof. Additionally, the term “Network interface” may also be referred to herein as “Communication interface” and such phrases/terms can be used interchangeably in the specifications.

Each of the components of the computer system 102 may be interconnected and communicate via a bus 118 or other communication link. As shown in FIG. 1, the components may be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computing devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near-field communication, ultra-band, or any combination thereof. Those skilled in the art will appreciate that additional networks 122 which are known and understood may additionally or alternatively be used and that the exemplary networks 122 are not limiting or exhaustive. Also, while the network 122 is shown in FIG. 1 as a wireless network, those skilled in the art will appreciate that the network 122 may also be a wired network.

The additional computing device 120 is shown in FIG. 1 as a personal computer. However, those skilled in the art will appreciate that, in alternative embodiments of the present application, the computing device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Those skilled in the art will appreciate that the above-listed devices are merely exemplary devices and that the computing device 120 may be any additional device or apparatus commonly known and understood in the art without departing from the scope of the present application. For example, the computing device 120 may be the same or similar to the computer system 102. Furthermore, those skilled in the art will similarly understand that the device may be any combination of devices and apparatuses.

Those skilled in the art will appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor 104 described herein may be used to support a virtual processing environment.

As described herein, various embodiments provide methods and systems to resolve an anomaly.

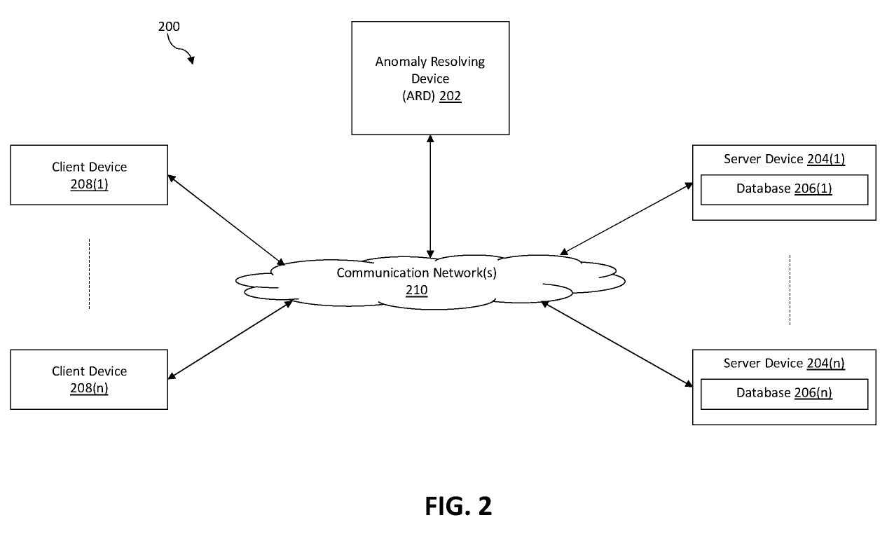

Referring to FIG. 2, a schematic of an exemplary network environment 200 to resolve an anomaly is illustrated. In an exemplary embodiment, the method is executable on any networked computer platform, such as, for example, a personal computer (PC).

The method to resolve an anomaly may be executed by an anomaly resolving device (ARD) 202. The ARD 202 may be the same or similar to the computer system 102 as described with respect to FIG. 1. The ARD 202 may store one or more applications that may include executable instructions that, when executed by the ARD 202, cause the ARD 202 to perform desired actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

In a non-limiting example, the application(s) may be operative in a cloud-based computing environment. The application(s) may be executed within or as a virtual machine(s) or virtual server(s) that may be managed in a cloud-based computing environment. Also, the application(s), and even the ARD 202 itself, may be located in the virtual server(s) running in a cloud-based computing environment rather than being tied to one or more specific physical network computing devices. Also, the application(s) may be running in one or more virtual machines (VMs) executing on the ARD 202. Additionally, in one or more embodiments of this technology, virtual machine(s) running on the ARD 202 may be managed or supervised by a hypervisor.

In the network environment 200 of FIG. 2, the ARD 202 is coupled to a plurality of server devices 204(1)-204(n) that hosts a plurality of databases 206(1)-206(n), and also to a plurality of client devices 208(1)-208(n) via communication network(s) 210. A communication interface of the ARD 202, such as the network interface 114 of the computer system 102 of FIG. 1, operatively couples and communicates between the ARD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ARD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides several advantages including methods, non-transitory computer-readable media, and ARDs that efficiently implement the method to resolve an anomaly.

By way of example only, the communication network(s) 210 may include local area network(s) (LAN(s)) or wide area network(s) (WAN(s)), and can use transmission control protocol/internet protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), public switched telephone networks (PSTNs), ethernet-based packet data networks (PDNs), combinations thereof, and the like.

The ARD 202 may be a standalone device or integrated with one or more other devices or apparatuses, such as one or more of the server devices 204(1)-204(n), for example. In one particular example, the ARD 202 may include or be hosted by one of the server devices 204(1)-204(n), and other arrangements are also possible. Moreover, one or more of the devices of the ARD 202 may be in the same or a different communication network including one or more public, private, or cloud-based networks.

The plurality of server devices 204(1)-204(n) may be the same or similar to the computer system 102 or the computing device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the ARD 202 via the communication network(s) 210 according to the hypertext transfer protocol (HTTP)-based and/or javascript object notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases or repositories 206(1)-206(n) that are configured to store data related to anomaly detection, mapped context associated with detected anomaly, processing and removal.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to-peer architecture, virtual machines, or within a cloud-based architecture, for example. Thus, the technology disclosed herein is not to be construed as being limited to a single environment and other configurations and architectures are also envisaged.

The plurality of client devices 208(1)-208(n) may also be the same or similar to the computer system 102 or the computing device 120 as described with respect to FIG. 1, including any features or combination of features described with respect thereto. For example, the client devices 208(1)-208(n) in this example may include any type of computing device that can interact with the ARD 202 via communication network(s) 210. Accordingly, the client devices 208(1)-208(n) may be mobile computing devices, desktop computing devices, laptop computing devices, tablet computing devices, or the like, that host chat, e-mail, or voice-to-text applications, for example. In an exemplary embodiment, at least one client device 208 is a wireless mobile communication device, e.g., a smartphone.

The client devices 208(1)-208(n) may run interface applications, such as standard web browsers or standalone client applications, which may provide an interface to communicate with the ARD 202 via the communication network(s) 210 in order to communicate user requests and information. The client devices 208(1)-208(n) may further include, among other features, a display device, such as a display unit or touchscreen, and/or an input device, such as a keyboard.

Although the exemplary network environment 200 with the ARD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the ARD 202, the server devices 204(1)-204(n), or the client devices 208(1)-208(n), for example, may be configured to operate as virtual instances on the same physical machine. In other words, one or more of the ARDs 202, the server devices 204(1)-204(n), or the client devices 208(1)-208(n) may operate on the same physical device rather than as separate devices communicating through communication network(s) 210. Additionally, there may be more or fewer ARDs 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, packet data networks (PDNs), the Internet, intranets, and combinations thereof.

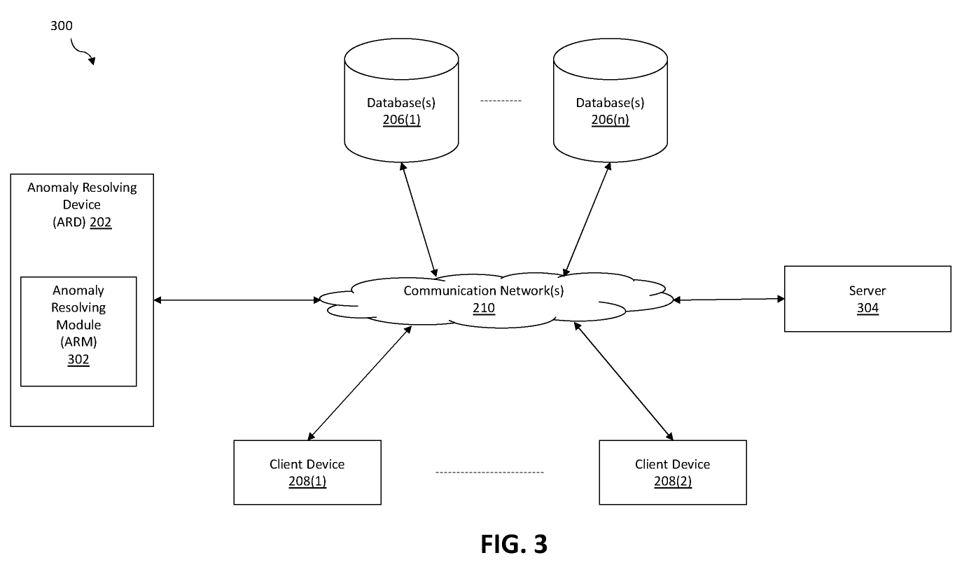

FIG. 3 illustrates a system diagram for implementing a method to resolve an anomaly, in accordance with an exemplary embodiment.

As illustrated in FIG. 3, the system 300 may include an ARD 202 within which an anomaly resolving module (ARM) 302 is embedded, a server 304, a database(s) 206(1) … 206(n), a plurality of client devices 208(1) … 208(2), and a communication network(s) 210.

According to exemplary embodiments, the ARD 202 including the ARM 302 may be connected to the server 304, and the database(s) 206(1) … 206(n) via the communication network(s) 210, but the disclosure is not limited thereto. The ARD 202 may also be connected to the plurality of client devices 208(1) … 208(2) via the communication network 210, but the disclosure is not limited thereto. The database(s) 206(1) … 206(n) may include a rule database.

In an embodiment, the ARD 202 is described and shown in FIG. 3 as including the ARM 302, although it may include other rules, policies, modules, databases, or applications, for example. As will be described below, the ARM 302 is configured to implement a method to resolve an anomaly.

An exemplary system 300 for implementing a mechanism to resolve an anomaly by utilizing the network environment of FIG. 2 is shown as being executed in FIG. 3. Specifically, a first client device 208(1) and a second client device 208(2) are illustrated as being in communication with the ARD 202. In this regard, the first client device 208(1) and the second client device 208(2) may be “clients” of the ARD 202 and are described herein as such. Nevertheless, it is to be known and understood that the first client device 208(1) and/or the second client device 208(2) need not necessarily be “clients” of the ARD 202, or any entity described in association therewith herein. Any additional or alternative relationship may exist between either or both of the first client device 208(1) and the second client device 208(2) and the ARD 202, or no relationship may exist.

Further, the ARD 202 is illustrated as being able to access one or more databases 206(1) …. 206(n). The ARM 302 may be configured to access these repositories/databases for implementing a method to resolve an anomaly. In some embodiments, the server 304 may be the same or equivalent to the server device 204 as illustrated in FIG. 2.

The first client device 208(1) may be, for example, a smartphone. The first client device 208(1) may be any additional device described herein. The second client device 208(2) may be, for example, a personal computer (PC). The second client device 208(2) may also be any additional device described herein.

The process may be executed via the communication network(s) 210, which may comprise plural networks as described above. For example, in an exemplary embodiment, either or both the first client device 208(1) and the second client device 208(2) may communicate with the ARD 202 via broadband or cellular communication. These embodiments are merely exemplary and are not limiting or exhaustive.

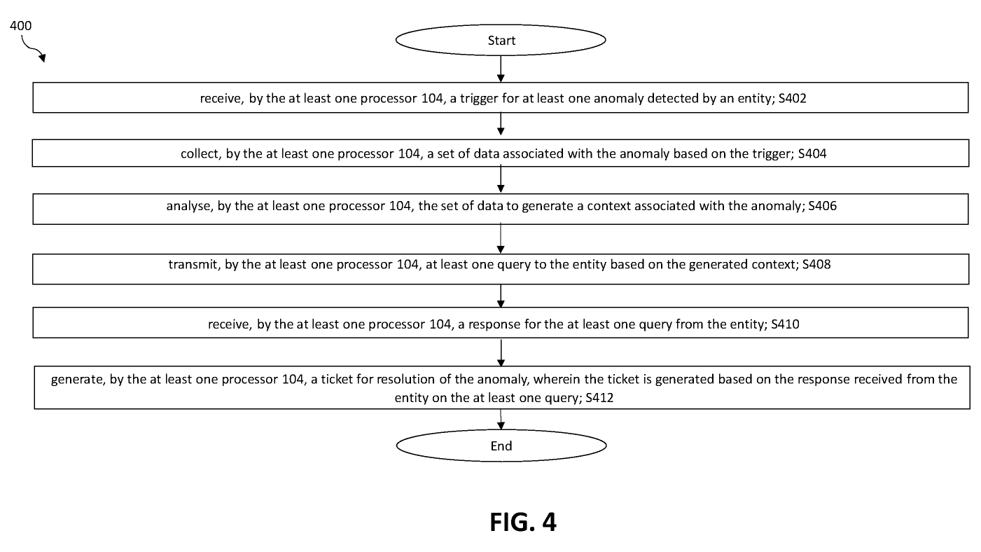

Referring to FIG. 4, an exemplary method 400 is shown to resolve an anomaly, in accordance with an exemplary implementation.

As shown in FIG. 4, the method 400 begins following a need to resolve anomaly detected or faced by a user while using an application of a service provider. The method 400 may be implemented by at least one processor 104.

At step S402, the method 400 may include receiving, by the at least one processor 104, a trigger for at least one anomaly detected by an entity.

In an exemplary implementation, the trigger may be received from the entity such as the user. In the application operation, when the user interacts with at least one service or feature over the application of the service provider, the user may detect at least one anomaly or face any issue or problem during the operation of the application. The issue or problem may be associated with such things as, but not limited to, being stuck on screen, displaying an error message, non-responsive feature, user interface screen or service and inconvenient service operation. The user may send the trigger via activating or touching at least one from among a specific region, icon, button, and widget on the application. In an exemplary embodiment, the trigger may be activated via at least an audio input.

In an exemplary implementation, the trigger may be sent by the application automatically based on the anomaly detected such as, screen stuck or error message after a pre-configured time interval.

It would be appreciated by the person skilled in the art that the aim here is to create a system that resolves anomalies detected in the application.

At step S404, the method may include collecting, by the at least one processor 104, a set of data associated with the anomaly based on the trigger.

In an exemplary implementation, the set of data associated with the anomaly may be collected after pre-configured time duration of the received trigger. The set of data may be collected such as screenshots, timestamps, and log details associated with the anomaly based on the trigger. For example, when the user activates a widget, a trigger associated with the anomaly is received. After receiving the trigger, the system waits for a pre-configured time range, such as, but not limited to, 30 seconds to 2 minutes. After completing this time duration, the set of data associated with anomalies such as e.g., user interface (UI) screen, error message or non-responsive feature may be collected in the form of screenshots with timestamps.

At step S406, the method may include analyzing, by the at least one processor 104, the set of data to generate a context associated with the anomaly.

In an exemplary implementation, the set of data may be analyzed using an assistant. The assistant may comprise a conversational AI based chatbot. The set of data may be analyzed using a machine learning based trained model. The machine learning based model may be trained to analyze and generate the context associated with the anomaly using previously collected errors, screenshots, log details, and compatibility issues. In an exemplary embodiment, the machine learning based model may be trained using at least one from among convolutional neural network (CNN) algorithms, natural language processing algorithms, reinforcement learning algorithms, anomaly detection algorithms and image/vision capturing and processing algorithms. Further, the machine learning based model may be trained periodically or on demand for the possible issues or challenges associated with detected anomaly. The trained data of machine learning based models may be stored in at least one storage device such as a server or database. After analyzing the set of data, the machine learning based model generates or maps the context associated with the detected anomaly. The mapping may be done based on the matching of the previously stored similar context associated with detected anomaly. The server or database may store a plurality of the context with the associated anomalies.

At step S408, the method may include transmitting, by the at least one processor 104, at least one query to the entity based on the generated context.

In an exemplary implementation, the at least one query may comprise a set of questionnaires that may be transmitted to the user based on the generated context associated with detected anomaly. For example, for generated context, such as ‘Xc’, the at least one query or questionnaires, such as, Xq1’ and ‘Xq2’ may be transmitted to the user based on the detected anomaly.

At step S410, the method may include receiving, by the at least one processor 104, a response for the at least one query from the entity.

In an exemplary implementation, the entity such as the user or application user after receiving the at least one query associated with the generated context, may check the correctness of the at least one query. The checking of correctness of the at least one query may represent that the transmitted query is corresponding to and appropriate for the detected anomaly or issues and challenges faced by the user. Further, in response to this, the user sends the response for the at least one query, which is received by the assistant. The response may at least one from among a positive feedback, a confirmation, a negative feedback, ratings, and a disapproval.

In an exemplary implementation, for the positive feedback, confirmation or good ratings, the response may be processed for further operation.

In an exemplary implementation, for the negative feedback, poor ratings or disapproval, at least a new query may be transmitted to the user. Further, the new query may be transmitted for a preconfigured count and a time duration gap. In another implementation, the user may be requested first to provide more information for regenerating a new context before sending the at least new query to the user.

In an exemplary implementation, the response associated with generated context and the at least one query may be stored in a database or server for training the machine learning based model.

At step S412, the method includes generating, by the at least one processor 104, a ticket for resolution of the anomaly, wherein the ticket may be generated based on the response received from the entity on the at least one query.

In an exemplary implementation, the ticket may be generated after receiving the response such as a positive response from the user on the at least one query for resolution of the detected anomaly. The ticket may be sent to at least one such member of the technical support team. In an exemplary implementation, the ticket may be sent based on type, severity or category of anomaly detected to the member of the technical support team. After analyzing the generated ticket, the technical support team may transmit a set of data associated with the ticket to a member of the application development team for resolving the detected anomaly.

In an exemplary implementation, the technical support team may communicate with the user for the detected anomaly before sending the ticket to the application development team.

After receiving the ticket, the application development team may incorporate at least one corrective action, such as, a modification, an upgrade, an update, and a deletion for resolving the detected anomaly. After receiving a solution of the detected anomaly, the user may send a feedback associated with the anomaly resolution.

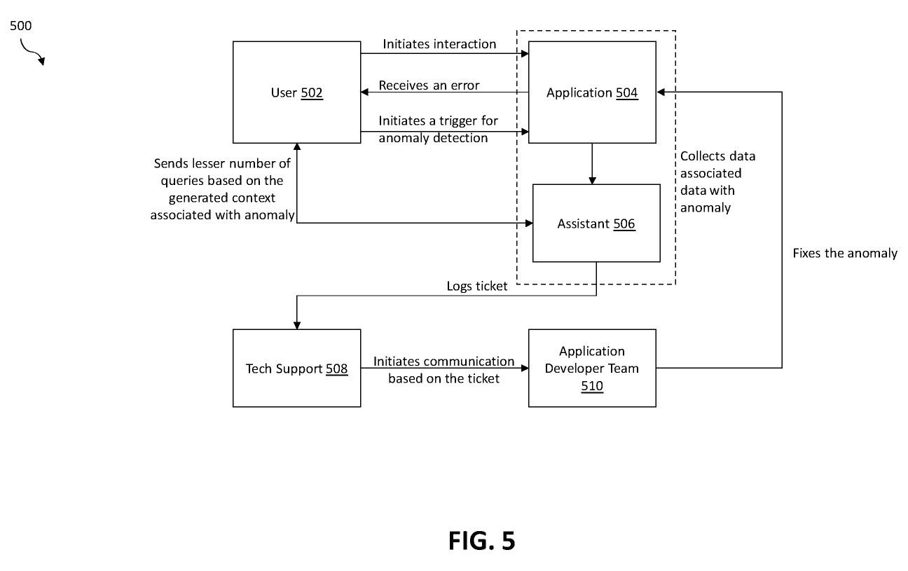

FIG. 5 illustrates an architecture of a system to resolve an anomaly, in accordance with an exemplary implementation. As illustrated in FIG. 5, the process flow 500 begins with initiating an interaction via a user 502 over an application 504 such as a banking application. During an operation, the user may face an anomaly or receive an error to operate the application. The issue or error may be such as, displaying an error, no response of feature, no response of UI screen of application, error in moving towards the next stage and inconvenient new feature or version usage of the application. After receiving the error, the user 502 may initiate a trigger for the detected anomaly due to the error. The trigger may be generated via the user 502 in the application 504 such as, via touching or activating a dedicated portion, area, symbol, icon or button. In an exemplary implementation, the trigger may be generated via an aid button. In an exemplary implementation, the trigger may be generated via an audio input.

After receiving the trigger for the detected anomaly, application 504 may start collecting a set of data associated with the anomaly such as, but not limited to, UI screenshots, timestamps, and log details. In an exemplary implementation, an aid module of application 504 may start collecting the set of data associated with the anomaly such as, but not limited to, screenshots of error message/screen, timestamps, and log details. After collecting the set of data, the application 504 may send this set of data to an assistant 506. In an exemplary implementation, the assistant 506 may be present within the application. In another implementation, the assistant 506 may be present in a cloud and communicatively coupled with the application 504.

Further, the assistant 506 may analyze the set of collected data using an artificial intelligence / machine learning (AI/ ML) based model. It is to be noted that the AI/ML based model is created and trained using different combinations of algorithms and images associated with the anomaly detection and resolution. Further, the image/screenshot data, error data and log data are loaded into the AI/ML based model. For example, the AI/ML based model may be loaded with the screenshots captured via the application 504 on the user device. Further, the present disclosure feeds such screenshots/images to the AI/ML based model to train and optimize the AI/ML based model. In an exemplary aspect, the set of data may be analyzed using a machine learning based trained model.

Based on the trained model, the assistant 506 may generate a context associated with the detected anomaly or issues faced by the user. The context may be generated based on the detected anomaly and may store further for training the AI/ML based model. In another implementation, the context may be mapped based on the detected anomaly. The mapping is done based on the matching of the previously stored similar context associated with detected anomaly. Further, based on the context generated, the assistant 506 may generate at least one query or a set of questions (e.g., targeted, or focused questions on problems) for resolving the anomaly. The generated at least one query may be transmitted to the user 502. In response to the at least one query, the user 502 may send to the assistant 506 a response to the at least one query. The response may be such as, but not limited to, positive, negative, rating, confirmation, or disapproval. In an exemplary implementation, the response represents that the at least one query is accurate and corresponds to the detected anomaly. Based on this response, the assistant 506 proceeds to further operation.

In another exemplary implementation, the response may represent that the at least one query is not accurate. Based on this response, at least one new query retransmitted to the user 502. This retransmission of at least one new query may be performed for a pre-configured count (e.g., 3) and time duration gap (e.g., 30 seconds).

In an exemplary implementation, the user may also provide a response for the generated context associated with the detected anomaly.

After receiving the confirmation response from the user 502, the assistant 506 may generate a ticket and sends it to a technical support team. In an exemplary implementation, the ticket may be sent based on type, severity or category of anomaly detected to the member of the technical support team. After analyzing the generated ticket, the technical support team may transmit a set of data associated with the ticket to an application development team for resolving the detected anomaly. The set of data associated with the ticket may include at least one from among the user identifier, device identifier, application version, error message, screenshot associated with detected anomaly.

After receiving the ticket, the application development team may incorporate at least one corrective action, such as, a modification, an upgrade, an update, and a deletion for resolving or fixing the detected anomaly. After receiving a solution of the anomaly, the user may send a feedback associated with the anomaly resolution.

It would be appreciated by the person skilled in the art that the disclosed method offers an effective, faster, and intelligent solution for implementing a method to resolve the anomaly.

It would be appreciated by the person skilled in the art that the disclosed method offers a solution not only for mobile applications, but also for web applications and web browsers in various business or applications fields.

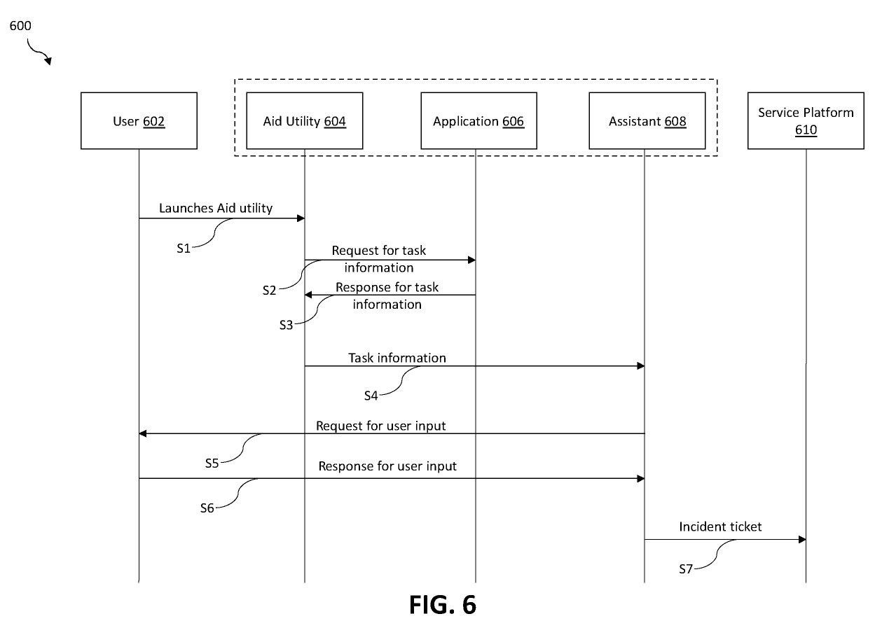

FIG. 6 illustrates a process flow of a system for resolving an anomaly, in accordance with an exemplary implementation. As illustrated in FIG. 6, the process 600 begins with activating an aid utility 604 via a user 602.

At step S1, the process 600 may include the user 602 encountering an issue or error message while operating an application 606. The user 602 thus activates the aid utility 604. At step S2, the process 600 may include the aid utility 604 sending a request for task information to the application 606. The task information here refers to details about the anomaly or issue faced by the user 602. At step S3, the process 600 may include the application 606 sending a response for the task information by providing task information that includes a screenshot of the user interface, error logs, and timestamps associated with the detected anomaly. At step S4, the process 600 may include the aid utility 604 collecting and forwarding the task information to an assistant 608 for further processing. The assistant 608 may utilize AI or ML based models to analyze the information (e.g., screenshots, error logs, and timestamps) and generate context around the anomaly. At step S5, the process 600 may include the assistant 608 generating one or more targeted or focused questions aimed at resolving the anomaly based on the generated context. The one or more questions are presented to the user in a simplified format, such as 'Yes' or 'No' responses, for easier interaction.

At step S6, the process 600 may include the assistant 608 receiving the user's responses. The assistant 608 may combine the user’s response with the previously collected task information. Using this data, the assistant 608 may determine the appropriate anomaly-resolving team by referencing stored information in a server or database. The determination includes evaluating the severity of the problem and identifying the team capable of addressing it effectively. At step S7, the process 600 may include the assistant 608 generating a support ticket (such as an incident ticket) on a service platform 610, embedding all relevant details such as screenshots, error logs, timestamps, user input, and team assignments. The ticket serves as a comprehensive record of the anomaly. Thereafter, the designated support team or an authorized team member may retrieve the generated ticket from the service platform 610 and perform the necessary corrective actions to resolve the anomaly efficiently.

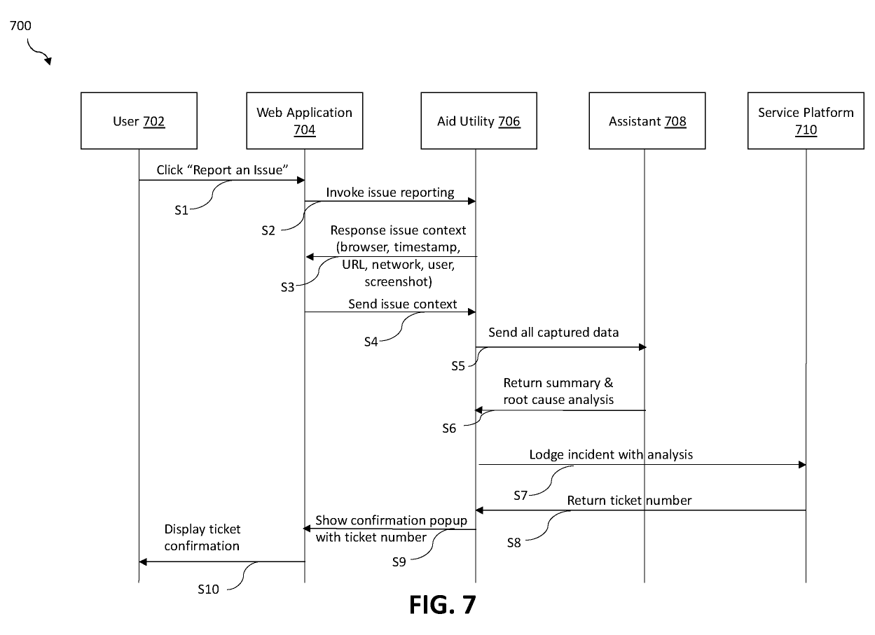

FIG. 7 illustrates a process flow 700 of a system for resolving an anomaly in a web-based application environment, in accordance with an exemplary embodiment of the present disclosure is disclosed. The process flow 700 depicts interactions among a user 702, a web application 704, an aid utility 706, an assistant 708, and a service platform 710 to enable intelligent, context-driven anomaly reporting and resolution.

The process 700 begins at step S1, wherein the user 702 may encounter an issue or anomaly while interacting with the web application 704. The anomaly may include an application error, page malfunction, unexpected behavior, network-related failure, or user interface inconsistency. In response, the user 702 may initiate an anomaly reporting action by selecting a predefined option within the web application 704, such as clicking a “Report an issue” interface element.

At step S2, upon receiving the anomaly reporting action, the web application 704 may invoke an issue reporting function of the aid utility 706. The invocation may trigger the aid utility 706 to request contextual information related to the detected anomaly from the web application 704.

At step S3, the web application 704 may respond to the request by generating and transmitting issue context information associated with the anomaly. The issue context information may include browser details, timestamp information, uniform resource locator (URL) data, network parameters, user identifiers, and screenshots captured at the time of anomaly detection.

At step S4, the web application 704 may forward the collected issue context information to the aid utility 706. The aid utility 706 may aggregate the information received and prepare it for further analysis.

At step S5, the aid utility 706 may transmit data associated with the anomaly to the assistant 708. In an exemplary implementation, the assistant 708 may be a large language model (LLM). The assistant 708 may analyze the received data using artificial intelligence and/or machine-learning-based techniques to derive insights related to the anomaly.

At step S6, the assistant 708 may generate and return a summarized analysis of the anomaly to the aid utility 706. The analysis may include a synthesized description of the issue, an inferred context, and a preliminary root cause determination based on learned patterns, historical anomalies, and contextual correlations.

At step S7, based on the generated analysis, the assistant 708 may initiate lodging of an incident with the service platform 710. The incident may include the anomaly analysis, captured context data, and any inferred categorization or severity information required for resolution.

At step S8, the service platform 710 may generate a support ticket corresponding to the lodged incident and transmits a ticket identifier back to the assistant 708. The ticket identifier may uniquely represent the anomaly within the service platform 710.

At step S9, the assistant 708 may forward the received ticket identifier to the aid utility 706, which in turn prompts the web application 704 to display a confirmation interface. The confirmation interface may include a popup or notification presenting the ticket identifier to the user 702.

At step S10, the web application 704 may display a ticket confirmation message to the user 702, thereby informing the user 702 that the anomaly has been successfully logged and is under resolution. The ticket confirmation may enable the user 702 to track progress or reference the anomaly in subsequent interactions.

The present disclosure provides numerous advantages as given below. The present disclosure provides a method and system for reducing the overall time taken by the automated system such as conversational AI based chatbots to log a support ticket on behalf of the user. The proposed solution reduces the overall time taken by the technology support teams to resolve an application issue reported by the user by providing a pre-synthesized, AI-generated contextual narrative that includes technical signals, execution evidence, and visual artifacts. The present disclosure improvises the user’s experience with the ticketing process. The present disclosure autonomously captures, aggregates, and analyzes contextual and environmental data associated with an application issue, without requiring explicit user intervention. By eliminating redundant user follow-ups and minimizing issue reproduction cycles, the proposed solution accelerates issue triage, root cause analysis, and resolution workflows. The present disclosure also boosts the user’s confidence to adopt chatbots as the go-to option for any resolutions.

Although the disclosure has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the disclosure has been described with reference to particular means, materials, and embodiments, the disclosure is not intended to be limited to the particulars disclosed; rather the disclosure extends to all functionally equivalent structures, methods, and uses such as are within the scope of the appended claims. For instance, the disclosure has been described with reference to an indoor or office environment; however, the disclosure is not intended to be limited to indoor environments and may also be implemented in outdoor environments.

For example, while the computer-readable medium may be described as a single medium, the term “computer-readable medium” includes a single medium or multiple media, such as a centralized or distributed database, and/or associated caches and servers that store one or more sets of instructions. The terms “computer-readable medium” and “computer-readable storage medium” shall also include any medium that is capable of storing, encoding, or carrying a set of instructions for execution by a processor 104 or that causes a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tape, or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

According to an aspect of the present disclosure, a non-transitory computer-readable storage medium storing instructions to resolve anomaly is disclosed. The instructions include executable code which, when executed by a processor 104, may cause the processor 104 to receive a trigger for at least one anomaly detected by an entity; collect a set of data associated with the anomaly based on the trigger; analyze the set of data to generate a context associated with the anomaly; transmit at least one query to the entity based on the generated context; receive a response for the at least one query from the entity; and generate a ticket for resolution of the anomaly, wherein the ticket is generated based on the response received from the entity on the at least one query.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “disclosure” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

We claim:

1. A method for resolving an anomaly, the method being implemented by at least one processor, the method comprising:
receiving, by the at least one processor, a trigger for at least one anomaly detected by an entity;
collecting, by the at least one processor, a set of data associated with the anomaly based on the trigger;
analyzing, by the at least one processor, the set of data to generate a context associated with the anomaly;
transmitting, by the at least one processor, at least one query to the entity based on the generated context;
receiving, by the at least one processor, a response for the at least one query from the entity; and
generating, by the at least one processor, a ticket for resolution of the anomaly, wherein the ticket is generated based on the response received from the entity on the at least one query.

2. The method as claimed in claim 1, wherein the trigger is received from the entity via activating or touching at least one from among a specific region, icon, button, and widget on an application, wherein the trigger is activated via at least an audio input.

3. The method as claimed in claim 1, wherein the set of data comprises at least one from among screenshots, timestamps, and log details associated with the anomaly.

4. The method as claimed in claim 1, wherein the set of data is analyzed using a machine learning based trained model.

5. The method as claimed in claim 4, wherein the machine learning based model is trained using at least one from among convolutional neural network (CNN) algorithms, natural language processing algorithms, reinforcement learning algorithms, anomaly detection algorithms and image/vision capturing and processing algorithms.

6. The method as claimed in claim 1, wherein the set of data associated with the anomaly is collected after pre-configured time duration of the received trigger.

7. The method as claimed in claim 1, wherein the response comprises at least one from among a positive feedback, a confirmation, a negative feedback, ratings, and a disapproval.

8. A computing device configured for resolving an anomaly, the computing device comprising:
a processor;
a memory storing instructions; and
a communication interface coupled to each of the processor and the memory, wherein the processor is programmed to cooperate with the instructions to perform operations comprising:
receiving a trigger for at least one anomaly detected by an entity;
collecting a set of data associated with the anomaly based on the trigger;
analyzing the set of data to generate a context associated with the anomaly;
transmitting at least one query to the entity based on the generated context;
receiving a response for the at least one query from the entity; and
generating a ticket for resolution of the anomaly, wherein the ticket is generated based on the response received from the entity on the at least one query.

9. The computing device as claimed in claim 8, wherein the trigger is received from the entity via activating or touching at least one from among a specific region, icon, button, and widget on an application, wherein the trigger is activated via at least an audio input.

10. The computing device as claimed in claim 8, wherein the set of data comprises at least one from among screenshots, timestamps, and log details associated with the anomaly.

11. The computing device as claimed in claim 8, wherein the set of data is analyzed using a machine learning based trained model.

12. The computing device as claimed in claim 11, wherein the machine learning based model is trained using at least one from among convolutional neural network (CNN) algorithms, natural language processing algorithms, reinforcement learning algorithms, anomaly detection algorithms and image/vision capturing and processing algorithms.

13. The computing device as claimed in claim 8, wherein the set of data associated with the anomaly is collected after pre-configured time duration of the received trigger.

14. The computing device as claimed in claim 8, wherein the response comprises at least one from among a positive feedback, a confirmation, a negative feedback, ratings, and a disapproval.

15. A non-transitory computer readable storage medium storing instructions for resolving an anomaly, the instructions comprising executable code which when executed by a processor, causes the processor to perform operations comprising:
receiving a trigger for at least one anomaly detected by an entity;
collecting a set of data associated with the anomaly based on the trigger;
analyzing the set of data to generate a context associated with the anomaly;
transmitting at least one query to the entity based on the generated context;
receiving a response for the at least one query from the entity; and
generating a ticket for resolution of the anomaly, wherein the ticket is generated based on the response received from the entity on the at least one query.

16. The non-transitory computer readable storage medium as claimed in claim 15, wherein the set of data comprises at least one from among screenshots, timestamps, and log details associated with the anomaly.

17. The non-transitory computer readable storage medium as claimed in claim 15, wherein the set of data is analyzed using a machine learning based trained model.

18. The non-transitory computer readable storage medium as claimed in claim 17, wherein the machine learning based model is trained using at least one from among convolutional neural network (CNN) algorithms, natural language processing algorithms, reinforcement learning algorithms, anomaly detection algorithms and image/vision capturing and processing algorithms.

19. The non-transitory computer readable storage medium as claimed in claim 15, wherein the set of data associated with the anomaly is collected after pre-configured time duration of the received trigger.

20. The non-transitory computer readable storage medium as claimed in claim 15, wherein the response comprises at least one from among a positive feedback, a confirmation, a negative feedback, ratings, and a disapproval.
